(19) United States
(12) Patent Application Publication
(10) Pub. No.: US 2007/0008464 A1
(43) Pub. Date: Jan. 11, 2007

(54) Liquid crystal display device

(75) Inventor: Masahiko Yamaguchi, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/481,223

(22) Filed: Jul. 5, 2006

(30) Foreign Application Priority Data
Jul. 8, 2005 (JP) 2005-200681

(51) Int. Cl. G02F 1/1335

(52) U.S. Cl. 349/112

(57) ABSTRACT

A liquid crystal display device is provided. The liquid crystal display includes a pair of oppositely arranged upper and lower substrates with liquid crystal interposed therebetween. A plurality of scan lines and a plurality of data lines are provided in grid pattern on the lower substrate. A scattering reflector is provided at each area divided by the scan lines and the data lines. A common electrode is provided below the upper substrate. A black matrix is provided below the upper substrate. A light-diffusing structure provided on a lower face of the black matrix. A plurality of color filters are provided at the black matrix, in which the light-diffusing structure includes an inclined face that is inclined relative to the faces of the pair of substrates.

This application claims the benefit of the Japanese Patent Application No. 2005-200681 filed on Jul. 8, 2005, which is hereby incorporated by reference.

### BACKGROUND

1. Field

A liquid crystal display device is provided.

2. Related Art

Display types of liquid crystal display devices generally include the transmission and semitransmission types provided with backlights, and the reflection type not provided with a backlight.

A transmission type liquid crystal display device can ensure an amount of light sufficient for liquid crystal display due to the provision of the backlight and provide bright liquid crystal display with high luminance. However, the device consumes large electricity. A reflection type liquid crystal display device only uses external light such as sunlight or illuminating light without the use of a backlight for displaying, and is widely adopted to, for instance, handheld terminals which are desired to be thin, light and less consumptive. A semitransmission type liquid crystal display device operates in transmission mode, in which a backlight lights in an environment without sufficient external light, or in reflection mode, in which the backlight does not light in an environment with sufficient external light. The semitransmission type liquid crystal display device is widely adopted in portable electric equipment such as mobile phones or portable personal computers.

A liquid crystal display device shown in FIG. 6 has been known as the one for effectively utilizing the external light and light of the backlight (see, Japanese Unexamined Patent Application Publication No. 2001-125088). The liquid crystal display device includes two transparent substrates 111 and 112 with liquid crystal 113 sealed between them. An insulation film 119 and a linear polarization plate 118 are formed on an outer face (display face) of the transparent substrate 111. A black mask 114 is formed on the insulation film 119. A diffusive adhesion layer 130 and a polarization/reflection film 116 are formed on an outer face of the transparent substrate 112, and a backlight is disposed on the outside thereof. The backlight is composed of a light source 117 and a light guide 131 for guiding light of the light source. An alignment film 123, a common electrode 121 and a transparent insulation film 120 are provided between the liquid crystal 113 and the transparent substrate 111. A plurality of color filters 115 are provided at the transparent insulation film 120. An alignment film 124, an interlayer insulation layer 126, pixel electrodes 125 and a thin-film transistor 127 are provided between the liquid crystal 113 and the transparent substrate 112.

When the liquid crystal display device is used as the reflection type liquid crystal display device, incident light a and b passed through a space not occupied by the black mask are reflected by the polarization/reflection film 116, pass through the color filters 115, then through the space not occupied by the black mask, and are observed as the liquid crystal display. Incident light c on the black mask 114 out of the light reflected by the polarization/reflection film 116 is partially reflected by a back portion 114b of the black mask and directed toward the polarization/reflection film 116 again. Then the light is reflected by the polarization/reflection film 116 again, passes through the color filters 115, then through the space not occupied by the black mask, and is observed as the liquid crystal display. Incident light d on the black mask is blocked by the black mask.

When the liquid crystal display device is used as the transmission type liquid crystal display device, the light of the backlight passes through the light guide 131 and irradiates the liquid crystal. The irradiated light passes through the color filters 115, then through the space not occupied by the black mask and is observed as the liquid crystal display. Incident light h on the black mask 114 out of the light of the backlight is reflected by the back portion 114b of the black mask 114, and is directed to the polarization/reflection film 116 again. Then the light is reflected by the polarization/reflection film 116 again, passes through the color filters 115, then through the space not occupied by the black mask and is observed as the liquid crystal display.

When the liquid crystal display device is used as the semitransmission type liquid crystal display device, the device operates in the same manner as the above-described reflection type liquid crystal display device while the external light is sufficiently ensured, or in the same manner as the above-described transmission type liquid crystal display device while the external light is not sufficiently ensured.

When the liquid crystal display device is used as the reflection type liquid crystal display device, upon the provision of the black mask 114 on the outer face (on an observation side) of the transparent substrate 111, the black mask 114 is not necessary between the color filters, so that a transparent region 115a can be provided between the color filters 115. The external light can pass through the transparent region 115a at a space not occupied by the color filters. The external light would be free from serious absorption due to the color filters 115 (namely, the external light does not pass through the color filters 115), and can be incident on the polarization/reflection film 116.

In the case where the black mask 114 is provided on the outer face of the transparent substrate 111 on the front while the transparent region 115a is provided on an inner face thereof, even though the black mask 114 overlaps the transparent region 115a, the light emitted from the peripheries of the black mask 114 can pass through the transparent region 115a because the black mask 114 is distant from the transparent region 115a by the thickness of the transparent substrate 111.

The provision of the black mask 114 on the front face of the transparent substrate 111 can provide clear contrast. When the liquid crystal display device is used as the transmission type liquid crystal display device, light, which advances perpendicularly to the transparent substrate 111, out of the light of the light source 117 of the backlight passed through the transparent region 115a at the space not occupied by the color filters can be blocked by the black mask 114 on the outer face of the transparent substrate 111. The contrast can be prevented from seriously deteriorating due to the light passed through the color filters. The light obliquely passed through a position (transparent region 115a) that corresponds to that of the black mask on the transparent substrate 111 on the front passes without impinging on the black mask 114 provided on the outer face of the transparent substrate 111. Since the refractive index of the transparent substrate 111 is different from that of the ambient air, the light will not pass through the transparent substrate 111 toward the air but reflected when the light passing through the interface between the transparent substrate 111 and the air is largely deviated from a perpendicular line, thereby being impossible to be emitted to the air.

The provision of the black mask 114 on the outer face on the transparent substrate 111 on the front provides the function similar to that the black mask is provided on the inner face of the transparent substrate 111. Since the back portion 114b of the black mask 114 serves as a reflection face that reflects the light, when the light passing through the transparent substrate 111 on the front from the rear face thereof impinges on the black mask 114, the light would not be absorbed by the black mask 114 but reflected by the reflection face (the back portion 114b) of the black mask 114 toward the polarization/reflection film 116. The light impinging on the black mask 114 is reflected by the polarization/reflection film 116 again to serve as the display light for an image without being absorbed.

Another liquid crystal display device as shown in FIGS. 7 and 8 has been known (see, Japanese Unexamined Patent Application Publication No. 2001-242445). The liquid crystal display device includes a first transparent electrode substrate 211 on an observation face side and an oppositely disposed second transparent electrode substrate 212 on a rear face side, the substrates being attached to each other with a perimeter sealing 213 interposed to form a predetermined cell gap between the substrates. Liquid crystal is injected into the cell gap. A liquid crystal layer 214 is the cholesteric-nematic phase transition type or the polymer dispersed type.

First light-shielding films 215, light-reflection films 218, a smoothing layer 221 and transparent electrodes 220 are provided on the first transparent electrode substrate 211. Second light-shielding films 216 and transparent electrodes 219 are formed on the second transparent electrode substrate 212. A backlight 217 is disposed on a rear face of the second transparent electrode substrate 212. A display part with the liquid crystal layer 214 sealed include a non-display region in a predetermined area and a display region in an area other than the predetermined area.

The non-display region has a plurality of sections each having the size of about 0.5×0.5 mm or greater. The first light-shielding films 215 with light-reflectivity are formed on the inner face of the first transparent electrode substrate 211 at the area corresponding to the non-display region, while the second light-shielding films 216 with light-absorbency are provided on the inner face of the second transparent electrode substrate 212 at the area corresponding to the display region. The surface of the first light-shielding film 215 is a fine-dimple surface, and the light-reflection film 218 is formed on the surface along the dimple. The light-reflection film 218 is formed by selectively plating nickel on the first light-shielding film 215.

When the backlight 217 is used, the light thereof is reflected by the first light-shielding films 215 on the first transparent electrode substrate side (observation face side) toward the second transparent electrode substrate 212 side (rear face side). Assuming that for instance the liquid crystal layer 214 is transparent with no voltage applied and is opaque with voltage applied due to selective reflection or light-scattering, if no voltage is applied, the light of the backlight passes through the liquid crystal layer 214 and is absorbed by the second light-shielding films 216 on the second transparent electrode substrate side, thereby not being emitted to the outside of the panel. If the voltage is applied, the light of the backlight is scattered and reflected by the liquid crystal layer 214, thereby being emitted to the outside of the panel.

Incidentally according to the configuration described in Japanese Unexamined Patent Application Publication No. 2001-125088, when being used as the reflection type, since the substantially straight light c, which has been reflected by the polarization/reflection film 116 and has passed through the space not occupied by the color filters 115, impinges on the back portion 114b of the black mask 114 and again reaches and is reflected by the polarization/reflection film 116, the light impinging on the black mask 114 can be reused. However, the light possibly passes through the color filters 115 when reflected by the back portion 114b of the black mask 114 toward the polarization/reflection film 116, thus causing attenuation of an amount of the light.

Similarly, when the structure is used as the transmission type, the light h passing through the space not occupied by the color filters 115 impinges on the back portion 114b of the black mask 114 and again reaches and is reflected by the polarization/reflection film 116, the light impinging on the black mask 114 can be reused. However, the light possibly passes through the color filters 115 when is reflected by the back portion 114b of the black mask 114 toward the polarization/reflection film 116, thus causing the attenuation of the amount of the light.

According to the configuration described in Japanese Unexamined Patent Application Publication No. 2001-242445, upon the application of drive voltage, the light emitted from the backlight 217 passes through the liquid crystal layer 214 and is reflected by the light-reflection film 218 on the first transparent electrode substrate side to be diffused reflection light. Due to the cholesteric liquid crystal in planar sequence in the display part D, light in specific wavelength band of the diffused reflection light is reflected to the outside of the panel.

Since acutely incident light on the light-reflection film 218, out of the light emitted from the backlight 217, is reflected by the light-reflection film 218 by a reflection angle substantially the same as the incident angle, the light will not be incident on the cholesteric liquid crystal region in planer sequence, thereby not making a contribution to the liquid crystal display. Although the first light-shielding film 215 has the fine-dimple on the surface toward the liquid crystal layer, and the light-reflection film 218 is formed along the dimple in order to enhance the light-scattering properties of the light-reflection film 218, the light-scattering properties thereof are not sufficient.

### SUMMARY

A liquid crystal display device capable of effectively using external light incident on a liquid crystal layer is provided.

A liquid crystal display device according to a first embodiment includes a pair of oppositely arranged substrates. Liquid crystal is interposed between the pair of substrates. A plurality of scan lines and a plurality of data lines are provided in grid pattern on a face toward the liquid crystal of one of the pair of substrates. A display electrode is provided at each area divided by the scan lines and the data lines. A switching element is connected to the display electrode. A counter electrode is provided on a face toward the liquid crystal of the other one of the pair of substrates. A black matrix is provided on the face toward the liquid crystal of the other one of the pair of substrates. A color filter is provided at each area divided by the black matrix. A light-diffusing structure is provided on a face toward the liquid crystal of the black matrix, in which the light-diffusing structure includes an inclined face that is inclined relative to the faces of the pair of substrates.

According to the configuration, the light incident on the light-diffusing structure is reflected by the light-diffusing structure, is incident on the scattering reflector, and then is reflected by the scattering reflector, thereby making a contribution to the liquid crystal display.

A liquid crystal display device according to a second emboidment of the present invention includes a pair of oppositely arranged substrates. Liquid crystal is interposed between the pair of substrates. A display electrode is provided on a face toward the liquid crystal of one of the pair of substrates. A counter electrode is provided on a face toward the liquid crystal of the other one of the pair of substrates, the counter electrode intersects with the display electrode. A black matrix is provided on the face toward the liquid crystal of the other one of the pair of substrates. A color filter is provided at each area divided by the black matrix. A light-diffusing structure is provided on a face toward the liquid crystal of the black matrix, in which the light-diffusing structure includes an inclined face that is inclined relative to the faces of the pair of substrates. With such a liquid crystal display device, the aforementioned problems can be addressed, and the same advantages can be attained as that of the liquid crystal display device according to the first aspect of the present invention as described above.

Note that, the expression that the display electrode intersects with the counter electrode means that the display electrode seems to intersect with the counter electrode when the liquid crystal device is seen from the one or the other one of the substrates (in plan view).

Further, a liquid crystal display device according to a third embodiment of the present invention includes a pair of oppositely arranged substrates. Liquid crystal is interposed between the pair of substrates. A display electrode is provided on a face toward the liquid crystal of one of the pair of substrates. A counter electrode is provided on a face toward the liquid crystal of the other one of the pair of substrates, the counter electrode intersecting with the display electrode. A black matrix is provided on the face toward the liquid crystal of the other one of the pair of substrates. A color filter is provided at an area of the one of the pair of substrates that corresponds to each area divided by the black matrix. A light-diffusing structure provided on a face toward the liquid crystal of the black matrix, in which the light-diffusing structure includes an inclined face that is inclined relative to the faces of the pair of substrates. With such a liquid crystal display device, the same advantages can be attained as that of the liquid crystal display device according to the first aspect of the present invention as described above.

Preferably, in the above-described liquid crystal display device, the inclined face may have an inclination angle in a range of about 25 to 40 degrees. With this configuration, the light incident on the light-diffusing structure is reflected by the light-diffusing structure, is reliably incident on the scattering reflector, and then is reflected by the scattering reflector, thereby reliably making a contribution to the liquid crystal display.

Preferably, in the above-described liquid crystal display device, the light-diffusing structure may have a triangular cross section with a tip toward the liquid crystal of the light-diffusing structure being the vertex. With this configuration, the light incident on the light-diffusing structure is reflected by the light-diffusing structure, is reliably incident on the scattering reflector, and then is reflected by the scattering reflector, thereby reliably making a contribution to the liquid crystal display.

Preferably, in the above-described liquid crystal display device, the light-diffusing structure may have a thickness greater than a film thickness of the color filter.

Preferably, in the above-described liquid crystal display device, the light-diffusing structure may be made of light-reflective metal. Preferably, in the above-described liquid crystal display device, the light-diffusing structure may be composed of a laminated body including a resin layer and a light-reflective metal layer. Preferably, in the above-described liquid crystal display device, the light-diffusing structure may be composed of a laminated body including a resin layer, an anti-reflective metal layer and a reflective metal layer. Preferably, the above-described liquid crystal display device may further include a backlight provided on a side opposite to the liquid crystal of the one of the pair of substrates. A pass hole is provided between the adjacent display electrodes, in which the light-diffusing structure may include the inclined face that reflects light that is emitted by the backlight and that passes through the pass hole. The light of the backlight may be utilized when an amount of the natural light is not sufficient, so that the light of the backlight is reliably reflected by the light-diffusing structure, thereby making a contribution to the liquid crystal display.

The liquid crystal display device that is provided is at least capable of effectively using the external light incident on the liquid crystal layer can be provided. In addition, the liquid crystal display device in which the light of the backlight is reflected toward the scattering reflector in a highly scattering manner to reliably make a contribution to the liquid crystal display can be provided.

### DRAWINGS

FIG. 1 is a planar configuration diagram of a reflection type liquid crystal display device;

FIG. 2 is a cross-sectional configuration diagram taken along line II-II of FIG. 1;

FIG. 3 is an enlarged view of a primary portion according to a first embodiment;

FIG. 4 is an enlarged view of a primary portion according to a second embodiment;

FIG. 5 is an enlarged view of a primary portion according to a third embodiment;

FIG. 6 is a cross-sectional view that shows an example of a reflection type liquid crystal display device of a related art;

FIG. 7 is a cross-sectional view showing another example of a reflection type liquid crystal display device of a related art; and

FIG. 8 is an enlarged cross-sectional view of a primary portion of FIG. 7.

### DESCRIPTION

Hereinafter, a liquid crystal display device according to the preferred embodiments when being adopted to an active matrix reflection type liquid crystal display device will be described below with reference to drawings. However, the prefereed embodiments are not limited to the following embodiments.

### FIRST EMBODIMENT

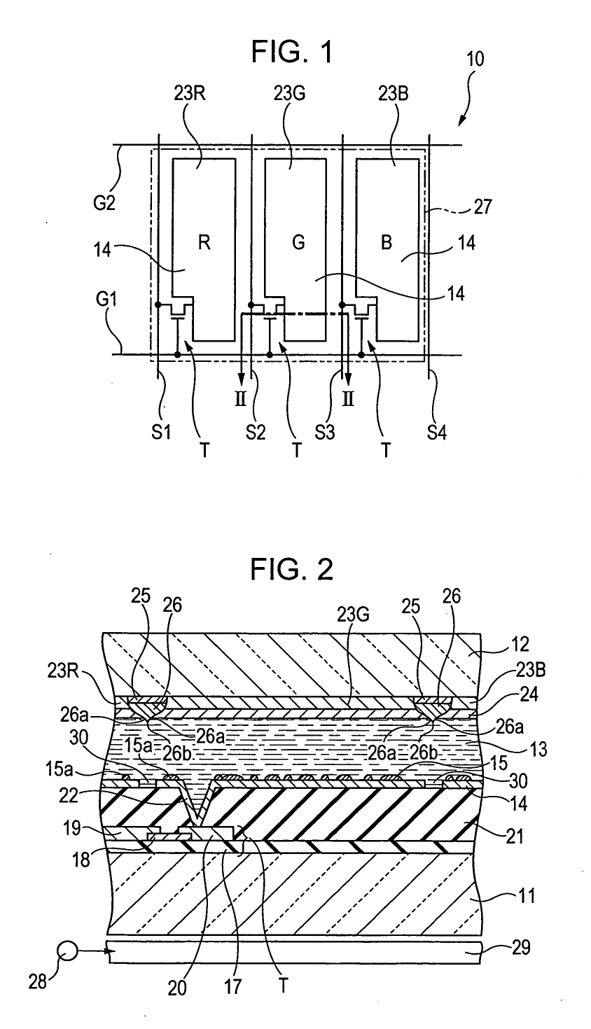

FIG. 1 is a planar configuration diagram of a reflection type liquid crystal display device according to the present embodiment, and FIG. 2 is a cross-sectional configuration diagram taken along line II-II of FIG. 1. A reflection type liquid crystal display device 10 of the present embodiment includes oppositely disposed lower substrate (one substrate) 11 and upper substrate (the other substrate) 12, and a liquid crystal layer 13 interposed between the substrates. The two glass substrates are attached to each other with a sealing (not shown) such that the cell gap therebetween is about 3 to 4 μm. Scattering reflectors 14, which also serve as a plurality of substantially rectangular pixel electrodes (display electrodes) arranged in grid pattern in plan view, and thin-film transistors (switching elements) T for pixel-switching arranged for the scattering reflectors 14, respectively, are provided on a face toward the liquid crystal of the lower substrate 11. Note that in FIG. 1, the thin-film transistors T are shown in an equivalent circuit diagram for ease of seeing the drawing.

The scattering reflector 14 is composed of the pixel electrode (display electrode) made of metal. The metal may be, for example, aluminum, an aluminum alloy, argentum or an argentum alloy as long as being electric conductive and light are reflective. A light-scattering portion 15 is arranged on an upper face of the scattering reflector 14. Since the scattering reflector 14 is made of the electric-conductive and light-reflective material, the scattering reflector 14 can serve as a reflection plate and the pixel electrode. The light-scattering portion 15 is provided for reliably scattering incident light when the light is reflected by the scattering reflector 14. A plurality of scattering dimples 15a are disposed on an upper face of the scattering reflector 14. The material of the light-scattering portion 15 is a transparent dielectric. The material may be selectively employed from an organic material, for example, acryl, polystyrene or polyimide and an inorganic material such as Si₃N₄. The above-mentioned scattering dimples 15a are preferably disposed irregularly.

The thin-film transistor T has a gate insulation layer 17 on a gate electrode (not shown) provided on the lower substrate 11, a-Si (amorphous silicon) semiconductor layers 18 provided on the gate insulation layer 17, and a source electrode 19 and a drain electrode 20 provided at each of the a-Si semiconductor layers 18. An interlayer insulation layer 21 covers the thin-film transistor T and the gate insulation layer 17. The above-mentioned scattering reflectors 14 are formed on the interlayer insulation layer 21. Contact holes 22 are formed at the interlayer insulation layer 21, so that the drain electrode 20 is connected to the scattering reflector 14, which serves as the pixel electrode, through the contact holes 22.

As shown in FIG. 1, the gate electrode of the thin-film transistor T is connected to a scan line G1 horizontally extending in the drawing, while the source electrode 19 is connected to a data line (signal line) S2 vertically extending in the drawing, respectively between the adjacent scattering reflectors 14. An alignment film (not shown) is provided to cover the scattering reflector 14 and the interlayer insulation layer 21.

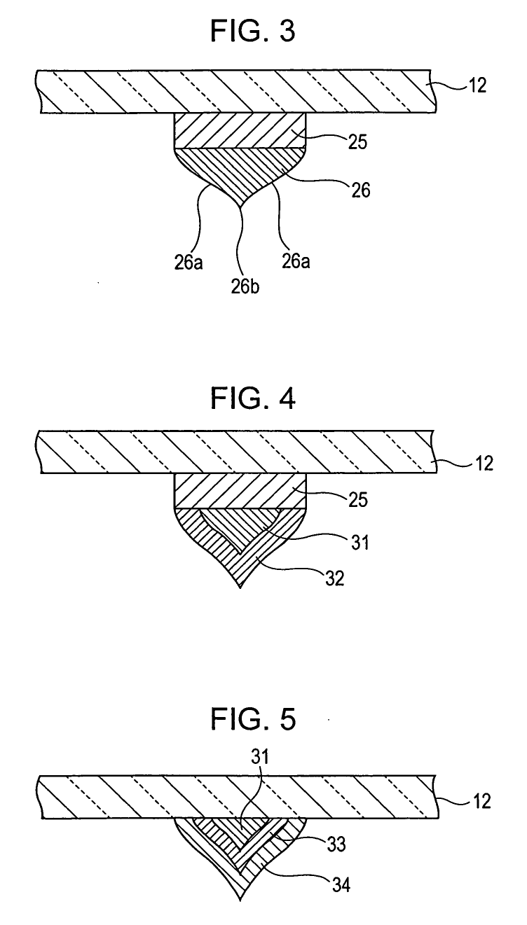

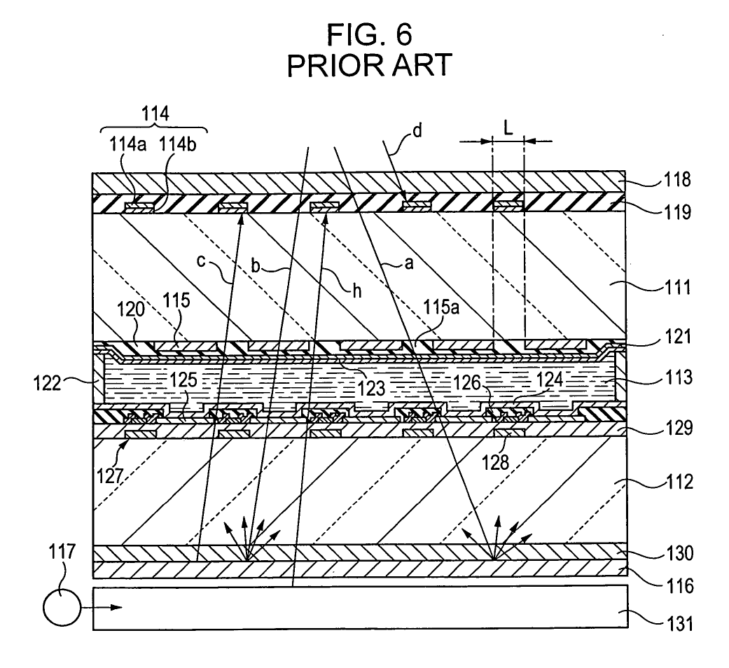

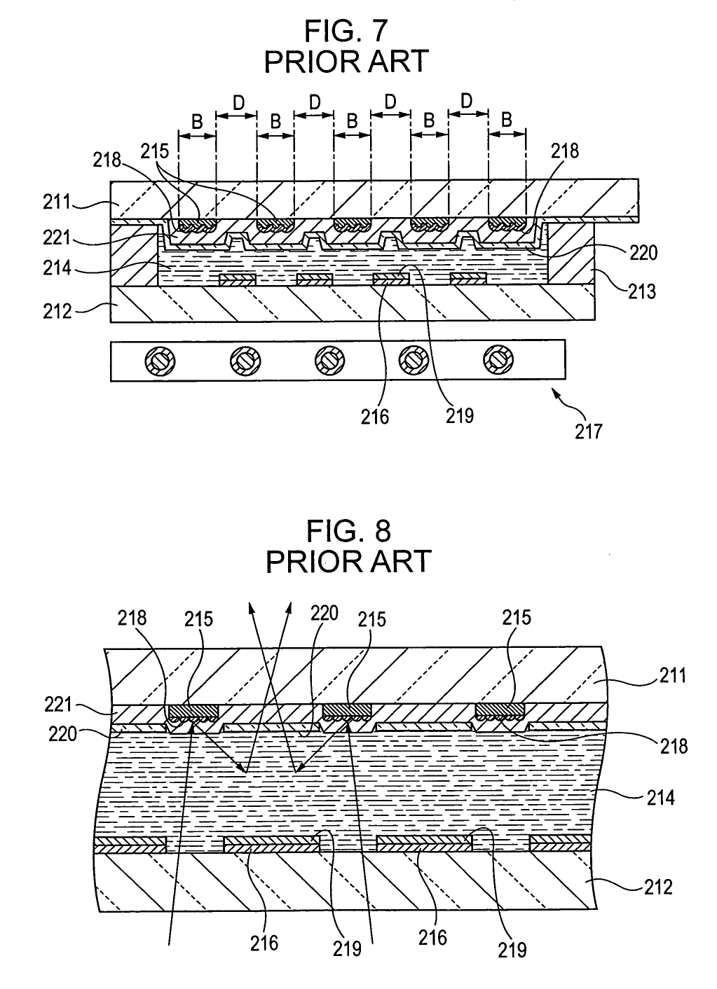

A black matrix 25 made of chrome is arranged in grid pattern in plan view on a face toward the liquid crystal of the upper substrate 12. The width of the black matrix is about 5 to 10 μm. A color filter layer 23 with the film thickness of about 1 μm is provided at a space not occupied by the black matrix. As shown in FIG. 3, light-diffusing structures 26 are provided on a face toward the liquid crystal of the black matrix 25. The light-diffusing structure 26 is made by depositing aluminum on the face toward the liquid crystal of the black matrix 25.

The light-diffusing structure 26 has inclined faces 26a to form an acute angle relative to the faces of the pair of substrates, and has a substantially triangular cross section with a tip 26b of the light-diffusing structure being the vertex. The light-diffusing structure 26 is so formed that the film thickness thereof is greater than that of the color filter layer 23. The film thickness of the light-diffusing structure 26 is about 1 to 3 μm. The tip 26b of the light-diffusing structure 26 protrudes beyond a face on the liquid crystal side of the color filter layer 23, toward the lower substrate 11. A transparent common electrode (counter electrode) 24 made of, for example, Indium Tin Oxide (hereinafter, referred to as ITO) is provided on a substantially entire face toward the liquid crystal of the color filter layer 23. An alignment film (not shown) covers the common electrode 24.

In addition, colored portions for red (R) 23R, colored portions for green (G) 23G, and colored portions for blue (B) 23B are provided at the color filter layer 23 at positions respectively facing the scattering reflectors 14 of the lower substrate 11. A region where the three scattering reflectors 14 associated with the respective colored portions which constitute the color filter layer 23 correspond to a single pixel 27. The size of the pixel is about 150 to 250 μm in width by about 150 to 250 μm in length.

The reflection type liquid crystal display device 10 with the above-described configuration controls electric potentials of the scattering reflectors 14 which serve as the pixel electrodes, by use of the thin-film transistors T to control light-transmission state of the liquid crystal layer 13 between the scattering reflector 14 and the common electrode 24 of the upper substrate 12, thereby providing liquid crystal display.

External light incident on the liquid crystal display device 10 is reflected by the scattering reflectors 14. Besides, by the control of the electric potential of the scattering reflectors 14, which also serve as the pixel electrodes, the liquid crystal display is provided. The light reflected toward the black matrix 25 out of the light reflected by the scattering reflectors 14 is reflected by the light-diffusing structures 26 and is incident on the scattering reflectors 14 again. The light is reflected by the scattering reflectors 14 again, and by the control of the electric potential of the scattering reflectors 14, which also serve as the pixel electrodes, the liquid crystal display is provided.

In addition, the liquid crystal display device 10 can be adopted to the transmission type liquid crystal display device if being provided with a backlight composed of a light source 28 and a light guide 29 on a face opposite to the liquid crystal of the lower substrate 11. Light emitted from the light source 28 advances toward the liquid crystal through the light guide 29, passes through pass holes 30 provided at a space not occupied by the plurality of scattering reflectors 14, and then incident on the light-diffusing structures 26.

The incident light on the light-diffusing structures 26 is reflected by the light-diffusing structures 26, and is incident on the scattering reflectors 14. The light is reflected by the scattering reflectors 14, and by the control of the electric potential of the scattering reflectors 14, which also serve as the pixel electrodes, the liquid crystal display is provided.

According to the liquid crystal display device 10, the inclination angle defined by the inclined face 26a of the light-diffusing structure 26 and the upper substrate 12 is preferably set within a range of about 25 to 40 degrees.

If the inclination angle is set below about 25 degrees, the light of the backlight is reflected by the light-diffusing structure 26. However, the amount of the light that reaches a center portion of the scattering reflector 14 decreases. Such light only makes a few contributions to the liquid crystal display.

If the inclination angle is set above 40 degrees, the light reflected by the light-diffusing structure 26 reaches the center portion of the scattering reflector 14. However, the amount of the light reflected to the vicinity of the light-diffusing structure 26 decreases. Accordingly, such light only makes a few contribution to the liquid crystal display. Since the height of the light-diffusing structure 26 will increase, the width of a black matrix is necessary to be decreased in order to make the cell gap to be a certain value, which causes yield loss thereof.

Note that the inclination angle is an angle defined by the inclined face 26a of the light-diffusing structure 26 and the upper substrate 12 if the inclined face 26a is planar, or a mean value of angles of inclination of the entire area on the inclined face 26a relative to the upper substrate 12 if the inclined face is curved.

### SECOND EMBODIMENT

A second embodiment is substantially the same as the first embodiment, except for a method of making a light-diffusing structure.

Specifically, as shown in FIG. 4, the light-diffusing structure according to the second embodiment has a resin film 31 (diffusion profile) made of resin provided on a face toward the liquid crystal of the black matrix 25 made of chrome, an aluminum film 32 made of aluminum covering the surface of the resin film 31.

### THIRD EMBODIMENT

A third embodiment is substantially the same as the first embodiment, except for a method of making a light-diffusing structure.

Specifically, as shown in FIG. 5, the light-diffusing structure according to the third embodiment has a resin film 31 (diffusion profile) made of resin provided on a face toward the liquid crystal of the glass substrate, a first chrome layer 33 made of anti-reflective chrome and a second chrome layer 34 made of light-reflective chrome sequentially covering the surface of the resin film 31. The first chrome layer 33 serves as a black matrix, whereas the second chrome layer 34 reflects light incident on the light-diffusing structure.

Note that in the above-described first to third embodiments, although the liquid crystal display device 10 adopted to the active matrix liquid crystal display device has been described, the present embodiments are not limited to these embodiments and appropriate modifications can be made within the scope of the present invention. For example, the preferred embodiments are adoptable to a simple matrix liquid crystal display device in which liquid crystal is interposed between oppositely disposed pair of substrates, and a scattering reflector, which also serves as a display electrode, is provided on one of the pair of substrates while a counter electrode intersecting with the display electrode is provided below the other one of the substrates. Although the scattering reflector, which also serves as the display electrode has been described in the embodiments. However, the display electrode may be provided separately from the scattering reflector. That is, an independent scattering reflector may be provided on an upper face of the display electrode.

Hereinafter, the preferred embodiments will be described in more detail below according to examples and a comparison. However, the preferred embodiments are not limited to these. For instance, a plurality of dimples may be provided on the surface of the light-diffusing structure to enhance light diffusing properties.

### EXAMPLE 1

Molybdenum was spattered on the one face of the glass substrate (lower substrate) 11 and made it in a desired profile with the photolithographic method to provide a gate electrode. A silicon nitride film was formed by the plasma CVD (chemical vapor deposition) method to cover the lower substrate 11 and the gate electrode to provide the gate insulation layer 17. After the formation of the a-Si semiconductor layer 18, aluminum was spattered thereon and the source electrode 19 and the drain electrode 20 were sequentially formed thereon to provide the thin-film transistor T. Then, the interlayer insulation layer 21 was formed to cover the thin-film transistor T and the gate insulation layer 17.

The contact holes 22 were provided above the drain electrodes. The scattering reflector 14 composed of the pixel electrode was made with aluminum on the interlayer insulation layer. The light-scattering portions 15 were provided on the scattering reflector. The alignment film (not shown) was provided on the scattering reflector 14 and the light-scattering portions. The alignment film was treated with rubbing treatment. A polarization plate (not shown) was provided on the other face of the glass substrate (lower substrate) 11.

The black matrix 25 made of chrome was spattered on the one face of the glass substrate (upper substrate) 12. The black matrix 25 was set to 7 μm in width by 0.15 μm in film thickness. The light-diffusing structures 26 made from aluminum films were provided on the black matrix 25. The light-diffusing structures 26 each were formed to have the triangular cross section with the tip 26b being the vertex. The color filter layer 23 was provided at the space not occupied by the black matrix. The film thickness of the light-diffusing structure 26 was set to 1.5 μm, while that of the color filter layer 23 was set to 1.0 μm. Accordingly, the tip 26b of the light-diffusing structure 26 was formed to project beyond the face on the liquid crystal side of the color filter layer 23, toward the lower substrate 11.

The common electrode 24 made of ITO was formed to cover the black matrix 25 and the color filter layer 23. The alignment film (not shown) was formed to cover the common electrode 24. The alignment film was treated with the rubbing treatment. In addition, a polarization plate (not shown) was provided on the other face of the glass substrate (upper substrate) 12. The two glass substrates were attached to each other with the sealing (not shown) such that the cell gap between the glass substrates was 4 μm, and the liquid crystal was injected through an injection hole to form a liquid crystal cell. The light guide 29 was disposed on a face toward the polarization plate of the glass substrate (lower substrate) 11. In addition, the light source 28 was disposed on a lateral face of the light guide 29. Note that the size of the pixel was set to 65 μm in width by 200 μm in length.

According to a semitransmission type liquid crystal display device, which was configured as described above, when the light source 28 emitted light with 2000 cd/m² in luminance, and a luminance on a display surface measured 40 cd/m².

### EXAMPLE 2

The film thickness of the black matrix was set to 0.15 μm. After the black matrix was post baked, transparent acrylic photosensitive resin was applied on the black matrix such that the film thickness thereof was 3 μm. Then the black matrix was exposed and developed to form the resin film. Exposing slightly and developing intensely made the cross section of the resin to be a tapered profile. Further, upon application of the post bake at 140° C. for 15 minutes, then at 220° C. for 320 minutes separately in two phases, a tapered angle thereof further decreased. The liquid crystal cell was formed under the same conditions as that of the example 1 except that the aluminum film 32 was formed on the resin film 31 such that the film thickness thereof was 0.1 μm.

According to a semitransmission type liquid crystal display device which used the above-described liquid crystal cell, when the light source 28 emitted light with 2000 cd/m² in luminance and a luminance on a display surface measured 40 cd/m².

### EXAMPLE 3

After the glass substrate was post baked, the transparent acrylic photosensitive resin was applied on the glass substrate such that the film thickness thereof was 3 μm, and then the glass substrate was exposed and developed to form the resin film. At this time, exposing slightly and developing intensely made the cross section of the resin to be a tapered profile. Further, upon application of the post bake at 140° C. for 15 minutes, then at 220° C. for 320 minutes separately in two phases, a tapered angle thereof further decreased. The first chrome layer 33 made of the anti-reflective chrome, which functions as the black matrix, was provided to be 0.1 μm in film thickness, and the second chrome layer 34 made of the reflective chrome to be 0.05 μm in film thickness sequentially on the resin layer 31. The liquid crystal cell was formed under the same conditions as that of the example 1 except for the above-described conditions.

According to a semitransmission type liquid crystal display device which used the above-described liquid crystal cell, when the light source 28 emitted light with 2000 cd/m² in luminance, and a luminance on a display surface measured 40 cd/m².

According to the results of examples 1 to 3, in the liquid crystal display device, since the light-diffusing structure was provided, the light incident on the light-diffusing structure was reflected by the light-diffusing structure and was incident on the scattering reflector, and then was reflected by the scattering reflector. This proved that the incident light on the light-diffusing structure could make a contribution to the liquid crystal display, thereby realizing high luminance.

### COMPARISON

According to a comparison, a semitransmission type liquid crystal display device was manufactured in the same manner as the example 1 except that the film thickness of the black matrix was set to 0.15 μm, and the light-diffusing structure was not formed on the face toward the liquid crystal of the black matrix. According to the transmission type liquid crystal display device, a luminance measured 1.0 cd/m².

What is claimed is:

1. A liquid crystal display device, comprising:
a pair of oppositely arranged substrates;
liquid crystal interposed between the pair of substrates;
a plurality of scan lines and a plurality of data lines provided in a grid pattern on a face toward the liquid crystal of one of the pair of substrates;
a display electrode provided at each area divided by the scan lines and the data lines;
a switching element connected to the display electrode;
a counter electrode provided on a face toward the liquid crystal of the other one of the pair of substrates;
a black matrix provided on the face toward the liquid crystal of the other one of the pair of substrates;
a color filter provided at each area divided by the black matrix; and
a light-diffusing structure provided on a face toward the liquid crystal of the black matrix,
wherein the light-diffusing structure includes an inclined face that is inclined relative to the faces of the pair of substrates.

2. The liquid crystal display device according to claim 1, wherein the inclined face has an inclination angle in a range of about 25 to 40 degrees.

3. The liquid crystal display device according to claim 1, wherein the light-diffusing structure has a triangular cross section with a tip toward the liquid crystal of the light-diffusing structure being the vertex.

4. The liquid crystal display device according to claim 1, wherein the light-diffusing structure has a thickness greater than a film thickness of the color filter.

5. The liquid crystal display device according to claim 1, wherein the light-diffusing structure is made of light-reflective metal.

6. The liquid crystal display device according to claim 1, wherein the light-diffusing structure is composed of a laminated body including a resin layer and a light-reflective metal layer.

7. The liquid crystal display device according to claim 1, wherein the light-diffusing structure is composed of a laminated body including a resin layer, an anti-reflective metal layer and a reflective metal layer.

8. The liquid crystal display device according to claim 1, further comprising:
a backlight provided on a side opposite to the liquid crystal of the one of the pair of substrates; and
a pass hole provided between the adjacent display electrodes,
wherein the light-diffusing structure includes the inclined face for reflecting light that is emitted by the backlight and that passes through the pass hole.

9. A liquid crystal display device, comprising:
a pair of oppositely arranged substrates;
liquid crystal interposed between the pair of substrates;
a display electrode provided on a face toward the liquid crystal of one of the pair of substrates;
a counter electrode provided on a face toward the liquid crystal of the other one of the pair of substrates, the counter electrode intersecting with the display electrode;
a black matrix provided on the face toward the liquid crystal of the other one of the pair of substrates;
a color filter provided at each area divided by the black matrix; and
a light-diffusing structure provided on a face toward the liquid crystal of the black matrix,
wherein the light-diffusing structure includes an inclined face that is inclined relative to the faces of the pair of substrates.

10. The liquid crystal display device according to claim 9, wherein the inclined face has an inclination angle in a range of about 25 to 40 degrees.

11. The liquid crystal display device according to claim 9, wherein the light-diffusing structure has a triangular cross section with a tip toward the liquid crystal of the light-diffusing structure being the vertex.

12. The liquid crystal display device according to claim 9, wherein the light-diffusing structure has a thickness greater than a film thickness of the color filter.

13. The liquid crystal display device according to claim 9, wherein the light-diffusing structure is made of light-reflective metal.

14. The liquid crystal display device according to claim 9, wherein the light-diffusing structure is composed of a laminated body including a resin layer and a light-reflective metal layer.

15. The liquid crystal display device according to claim 9, wherein the light-diffusing structure is composed of a laminated body including a resin layer, an anti-reflective metal layer and a reflective metal layer.

16. The liquid crystal display device according to claim 9, further comprising:
a backlight provided on a side opposite to the liquid crystal of the one of the pair of substrates; and
a pass hole provided between the adjacent display electrodes,
wherein the light-diffusing structure includes the inclined face for reflecting light that is emitted by the backlight and that passes through the pass hole.

17. A liquid crystal display device, comprising:
a pair of oppositely arranged substrates;
liquid crystal interposed between the pair of substrates;
a display electrode provided on a face toward the liquid crystal of one of the pair of substrates;
a counter electrode provided on a face toward the liquid crystal of the other one of the pair of substrates, the counter electrode intersecting with the display electrode;
a black matrix provided on the face toward the liquid crystal of the other one of the pair of substrates;
a color filter provided at an area of the one of the pair of substrates corresponding to each area divided by the black matrix; and
a light-diffusing structure provided on a face toward the liquid crystal of the black matrix,
wherein the light-diffusing structure includes an inclined face that is inclined relative to the faces of the pair of substrates.

18. The liquid crystal display device according to claim 17, wherein the inclined face has an inclination angle in a range of about 25 to 40 degrees.

19. The liquid crystal display device according to claim 17, wherein the light-diffusing structure has a triangular cross section with a tip toward the liquid crystal of the light-diffusing structure being the vertex.

20. The liquid crystal display device according to claim 17, wherein the light-diffusing structure has a thickness greater than a film thickness of the color filter.

21. The liquid crystal display device according to claim 17, wherein the light-diffusing structure is made of light-reflective metal.

22. The liquid crystal display device according to claim 17, wherein the light-diffusing structure is composed of a laminated body including a resin layer and a light-reflective metal layer.

23. The liquid crystal display device according to claim 17, wherein the light-diffusing structure is composed of a laminated body including a resin layer, an anti-reflective metal layer and a reflective metal layer.

24. The liquid crystal display device according to claim 17, further comprising:
a backlight provided on a side opposite to the liquid crystal of the one of the pair of substrates; and
a pass hole provided between the adjacent display electrodes,
wherein the light-diffusing structure includes the inclined face for reflecting light that is emitted by the backlight and that passes through the pass hole.
